(19) United States
(12) Patent Application Publication
(10) Pub. No.: US 2004/0134947 A1
(43) Pub. Date: Jul. 15, 2004

(54) Clamp for a vehicle gun rack

(76) Inventors: Kurt R. Murray, Carmel, IN (US); Ben Muilenburg, Fishers, IN (US); Jeffrey T. Bounds, Fishers, IN (US)

Correspondence Address: Intellectual Property Group, Bose McKinney & Evans LLP, 2700 First Indiana Plaza, 135 North Pennsylvania Street, Indianapolis, IN, 46204, US

(21) Appl. No.: 10/694,409

(22) Filed: Oct. 27, 2003

Related U.S. Application Data
(60) Provisional application No. 60/421,501, filed on Oct. 25, 2002.

(51) Int. Cl. B60R 7/00

(52) U.S. Cl. 224/311; 224/913

(57) ABSTRACT

A clamp for securing a gun rack to a vehicle including an elongated frame member and first and second clamp members.

### CROSS-REFERENCE TO RELATED APPLICATION

This application claims priority to U.S. Provisional Patent Application Serial No. 60/421,501, filed Oct. 25, 2002, the disclosure of which is expressly incorporated by reference herein.

### BACKGROUND AND SUMMARY OF THE INVENTION

The present invention relates to vehicle gun racks, and more particularly to a clamp for a vehicle gun rack configured to support the vehicle gun rack adjacent to the roof of a vehicle. The present invention further relates to a clamp for a vehicle gun rack that can be clamped to sides of the vehicle frame adjacent to the rear doors of the vehicle without the need to drill holes in the vehicle or in any other manner penetrate the vehicle for installation of the clamp and of the vehicle gun rack in the passenger compartment of the vehicle.

According to an illustrative embodiment of the present invention, a clamp is provided for fixing a weapon holder to a vehicle. The clamp includes an elongated frame member and a first clamp member coupled to the frame member. A second clamp member is coupled to the frame member and is spaced apart from the first clamp member. A tightener is supported by the frame member and is coupled to at least one of the first and second clamp members so that the second clamp member moves relative to the first clamp member to mount the clamp to the vehicle.

A gun rack in accordance with an illustrative embodiment of the present invention includes a weapon holder fixed to the clamp and configured to carry a weapon. The frame member of the clamp couples to the weapon holder which supports the weapon within the passenger compartment of the vehicle. The weapon holder illustratively includes a bracket coupled to the frame member and arms extending outwardly from the bracket for supporting the weapon. Illustratively, the weapon holder may include a gun lock for locking the weapon to the holder.

Illustratively, the frame member is clamped to the vehicle by the first clamp member coupled to a first end of the frame member and the second clamp member coupled to a second end of the frame member. A first threaded fastener secures the first clamp member to the frame member and a second threaded fastener secures the second clamp member to the frame member.

Further illustratively, each clamp member includes a vehicle-engaging portion and an attachment portion configured to couple the clamp member to the frame member. The attachment portion includes a generally horizontal plate formed to receive one of the first and second threaded fasteners and a spaced-apart pair of generally vertically-extending flanges appended to the plate and extending downwardly therefrom. The flanges are spaced-apart so that when the clamp member is installed on the frame member and the respective fastener is received in the attachment portion, the flanges engage opposing sides of the frame member to prevent rotation of the clamp member about an axis defined by the fastener.

The vehicle-engaging portion is configured to curl around a rim of a door frame of the vehicle. When the first and second clamp members are mounted to the frame member and the clamp is mounted to the vehicle, tips of the vehicle-engaging portions of the first and second clamp members are in an opposing relation engaging the door frames so that the clamp and the weapon holder are securely clamped to the vehicle.

Additional features and advantages of the invention will become apparent to those skilled in the art upon consideration of the following detailed description when taken in conjunction with the accompanying drawings.

### BRIEF DESCRIPTION OF THE DRAWINGS

The detailed description of the drawings particularly refers to the accompanying figures in which:

FIG. 1 is a partial perspective view, with portions broken away, of a vehicle gun rack according to an illustrative embodiment of the present invention including a weapon holder fixed to a clamp that is mounted in the passenger compartment of a vehicle;

FIG. 2 is a front elevational view of the vehicle gun rack of FIG. 1 showing a weapon held by the weapon holder;

FIG. 3 is an exploded top perspective view of an illustrative embodiment clamp of the present invention;

FIG. 4 is an exploded bottom perspective view of the clamp of FIG. 3;

FIG. 5 is a detailed perspective view of the second clamp member coupled to the frame member of FIG. 4;

FIG. 6 is a perspective view of a further illustrative embodiment clamp of the present invention;

FIG. 7 is an exploded perspective view of the clamp of FIG. 6;

FIG. 8 is a partial cross-sectional view taken along line 8-8 of FIG. 6;

FIG. 9 is a perspective view of a further illustrative embodiment clamp of the present invention;

FIG. 10 is a detailed perspective view of the clamp of FIG. 9; and

FIG. 11 is a detailed perspective view of the tightening device of the clamp of FIG. 9.

### DETAILED DESCRIPTION OF THE DRAWINGS

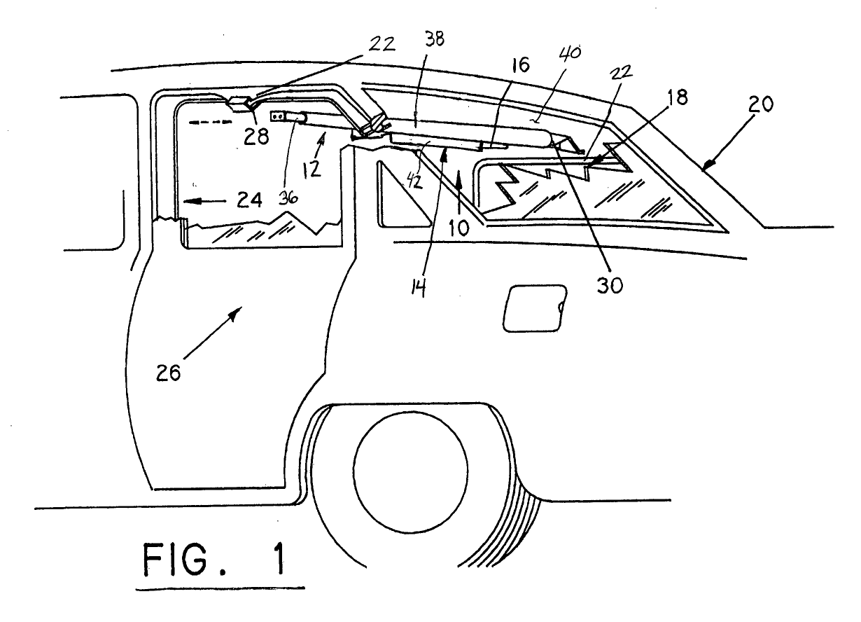

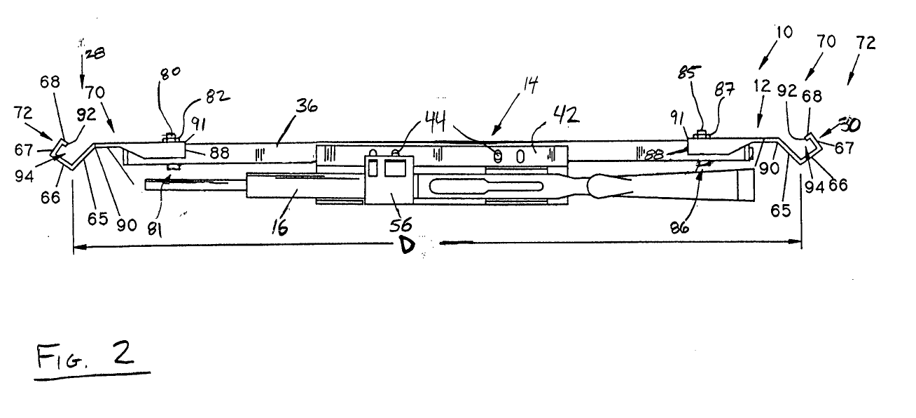

A vehicle gun rack 10 including a clamp 12 in accordance with an illustrative embodiment of the present invention is illustrated in FIGS. 1 and 2. A weapon holder 14 may be attached to the clamp 12 and is configured to carry a weapon 16 for mounting in a passenger compartment 18 of a vehicle 20. Illustrative clamp 12 is clamped to opposing rims 22 of door frames 24 of rear doors 26 of vehicle 20.

The weapon holder 14 is configured to be positioned proximate to a ceiling 40 of passenger compartment 18 when the clamp 12 is clamped to the rims 22 of door frames 24. Weapon holder 14 illustratively includes a bracket 42 configured to carry weapon 16. Bracket 42 is illustratively secured to the clamp 12 through conventional fasteners, such as bolts 43 threadably receiving nuts 44. A spacer 45 and a washer 46 may be received on each bolt 43 intermediate the clamp 12 and the nut 44.

The weapon holder 14 may include horizontally-extending arms 47 defining a gun-receiving space for receiving weapon 16. A gun lock 56 may be coupled to the bracket 42 to lock weapon 16 to the weapon holder 14. Additional details of an illustrative weapon holder are provided in U.S. Pat. No. 5,816,546 which is assigned to the assignee of the present invention and is expressly incorporated by reference herein. It should be appreciated that any other weapon holder which can be fixed to frame member 36 may be substituted for weapon holder 14.

The clamp 12 includes a single frame member 36 having a first end 32 and a second end 34 coupled to a first clamp member 28 and a second clamp member 30, respectively. The first clamp member 28 cooperates with the second clamp member 30 to clamp the vehicle gun rack 10 to the vehicle 20. If desired, the frame member 36 may be covered by padding 38, for example, a sponge or foam rubber tube may be wrapped around a portion of the frame member 36.

The frame member 36 of the clamp 12 is illustratively formed from a single piece of square steel stock having an elongated top 110, an elongated bottom 112 spaced apart from the top 110, and spaced-apart elongated first and second sides 114, 116 integrally appended to top 110 and bottom 112. The top 110, the bottom 112, the first side 114 and the second side 116 cooperate to define an interior region 118 of the frame member 36.

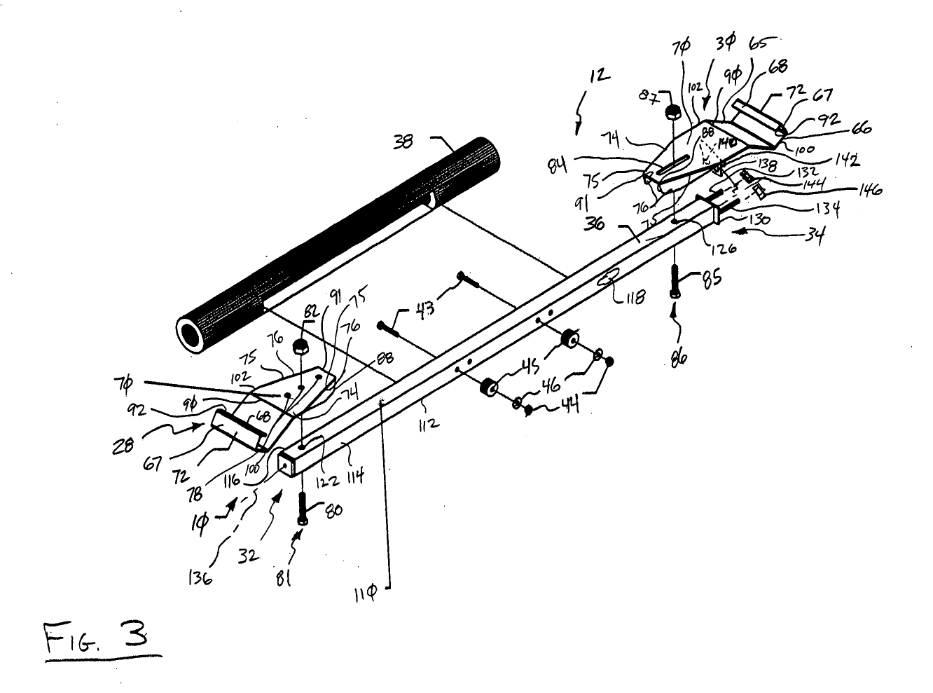

The first and second clamp members 28 and 30 are coupled to the frame member 36 as shown in FIG. 3. The first clamp member 28 is substantially similar to the second clamp member 30, but for the structure for securing the clamp member 28, 30 to the frame member 36 as detailed below. Thus, the description below of the first clamp member 28 will also generally apply to the second clamp member 30 except as specifically stated otherwise.

The first clamp member 28 includes an attachment portion 70 configured to engage the frame member 36 and a vehicle-engaging portion 72 configured to engage rims of door frames of the vehicle. The attachment portion 70 includes a generally horizontal plate 74 configured to lay against the frame member 36. The plate 74 includes two spaced-apart longitudinally-extending side edges 75 and an outer edge 90 extending therebetween, and an inner edge 91 longitudinally spaced apart from the outer edge 90 and extending between the first and second side edges 75. The plate 74 is also formed to include a plurality of longitudinally spaced-apart openings 78. Illustratively as shown in FIG. 3, the plurality of longitudinally spaced-apart openings 78 includes three openings 78, each of which is configured to receive the threaded post 80 of a first fastener 81 extending upwardly from the frame member 36. A nut 82 is threadably received by the threaded post 80 to secure the first clamp member 28 to the frame member 36 in a conventional manner. While FIG. 3 illustrates a conventional bolt 81, it should be appreciated that the threaded post 80 may be permanently fixed, as by welding, to the frame member 36.

The second clamp member 30 differs from the first clamp member 28 in that the second clamp member 30 does not have a plurality of spaced-apart openings 78, but instead includes a longitudinally extending slot 84. The longitudinally extending slot 84 is configured to receive a threaded post 85 of a second fastener 86 which threadably receives a nut 87. The second fastener 86 and nut 87 are identical to the first fastener 81 utilized to secure the first clamp member 28 to the frame member 36. Again, the threaded post 85 may be permanently fixed to the frame member 36.

Since the frame member 36 comprises a rigid member and is not adjustable, the clamp 12 can accommodate varied distances D (FIG. 2) between rims 22 of door frames 24 by adjusting the position of the second clamp member 30 relative to the first clamp member 28. The distance is initially adjusted by selecting the appropriate opening 78 of the first clamp member 28 to receive the threaded post 80. Likewise, the second clamp member 30 may be adjusted by slidably moving the clamp member 30 along the frame member 36 and, more particularly, by slidably moving the slot 84 relative to the threaded post 85 received therein.

First and second spaced-apart flanges 76 are appended to side edges 75 of the plate 74 of attachment portion 70 of the clamp members 28 and 30. The flanges 76 are configured to receive the frame member 36 therebetween so that the flanges 76 are positioned to lie adjacent to opposing sides of the frame member 36. Each flange 76 includes an inner edge defining a stop 88 engaging the frame member 36. The stops 88 are thus positioned to lie on both sides of the frame member 36 and cooperate with the threaded post 80, 85 to prevent rotation of the attachment portion 70 of the first clamp member 28 relative to the frame member 36 about the threaded post 80, 85.

The vehicle-engaging portion 72 extends from the edge 90 to a tip 92 and is curled so that the tip 92 is spaced apart from edge 90 and so that the tip 92 opposes the edge 90. The vehicle-engaging portion 72 also includes first and second spaced-apart sides 100 and 102 extending between the edge 90 and the tip 92.

Illustratively, the vehicle-engaging portion 72 includes a downwardly-angled first plate 65 appended to the edge 90 and extending downwardly and outwardly therefrom, an upwardly-angled second plate 66 appended to the first plate 65 and extending upwardly and outwardly therefrom, an upwardly-angled third plate 67 spaced apart from the first plate 65, appended to the second plate 66, and extending upwardly and inwardly therefrom, and a downwardly-angled fourth plate 68 appended to the third plate 67, spaced apart from the second plate 66, and extending inwardly and downwardly therefrom to terminate at the tip 92. While in the illustrative embodiment, the vehicle-engaging portion 72 includes first, second, third, and fourth angled plates 65, 66, 67, 68, it should be appreciated that the vehicle-engaging portion 72 may include as many angled plates as desired, or may include a continuous curved plate. Any structure of the clamp members 28, 30 may be utilized to engage opposing rims 22 of the door frames 24 of vehicle 20 to mount the vehicle gun rack 10 to the vehicle 20.

As described above, the clamp 12 includes the threaded post 80 extending upwardly from the top 110 of the frame member 36 adjacent to the second end 34 of the frame member 36, and the threaded post 85 extending upwardly from the top 110 of the frame member 36 adjacent to the first end 32 of the frame member 36. The first threaded post 80 extends upwardly through an opening 122 formed in the top 110 of the frame member 36 and illustratively may be welded to the top 110. The second threaded post 85 extends upwardly through an opening 126 formed in the top 110 of the frame member 36 and again illustratively may be welded to the top 110.

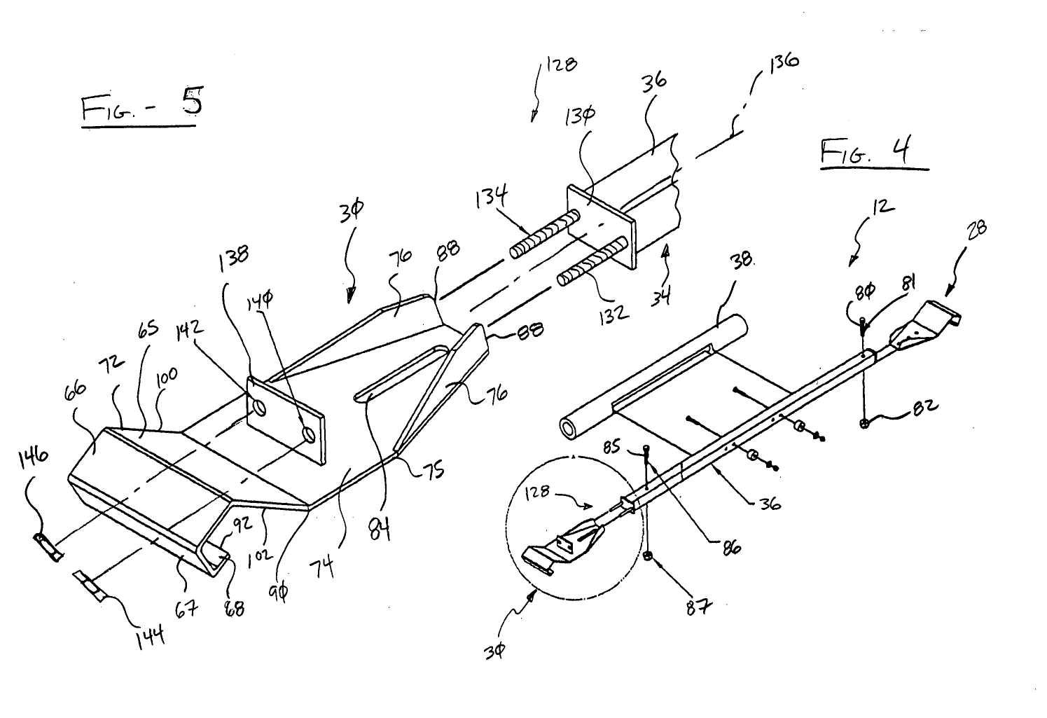

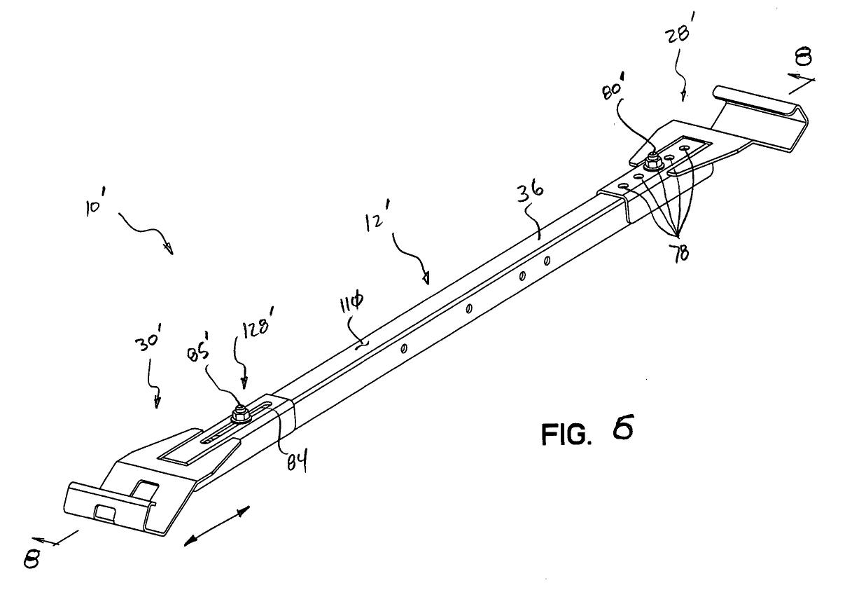

With further reference to FIGS. 4 and 5, a tightener 128 couples the second end 34 of the frame member 36 to the second clamp member 30. The tightener 128 includes a tightening plate 130 which is coupled to the second end 34 of the frame member 36 and supports a pair of longitudinally extending threaded tightening posts 132, 134. The tightening posts 132, 134 are bi-axially disposed substantially parallel to, and spaced apart from, a longitudinal axis 136 of the frame member 36. A tightening tab 138 extends downwardly from the second clamp member 30 and includes a pair of apertures 140, 142 configured to receive the threaded tightening posts 132, 134. A user input, illustratively a pair of tightening nuts 144, 146 may be threadably received on the tightening posts 132, 134. As described above, the second clamp member 30 includes an elongated slot 84 which receives the threaded post 85 of the second fastener 86. As the tightening nuts 144, 146 are rotated by the user onto the threaded tightening posts 132, 134 in a clockwise direction, the tightening tab 138 causes the second clamp member 30 to move relative to the frame member 36. More particularly, the second clamp member 30 moves in a direction toward the first clamp member 28, which is fixed to the frame member 36.

The installation of the vehicle gun rack 10 into a vehicle begins with the placement of the first and second clamp members 28, 30 on the first and second ends 32 and 34 of the frame member 36. More particularly, the second clamp member 30 is coupled to the second end 34 of the clamp member 36 by sliding the apertures 140 and 142 of the tightening tab 138 over the tightening posts 132 and 134. Next, the threaded post 85 is received within the slot 84 formed within the second clamp member 30. The nut 87 is then threadably received on the threaded post 85 but not fully tightened into securing engagement with the second clamp member 30 such that the clamp member 30 may move relative to the threaded post 85. The first clamp member 28 is next installed on the threaded post 80 by selecting an appropriate opening 78 so that the distance between the tips 92 of the first and second clamp members 28 and 30 is approximately equal to a distance between the rims of the door frames of the vehicle. The nut 82 is then threadably received on the threaded post 80 and tightened to secure the first clamp member 28 to the frame member 36. The clamp 12 is next positioned by the user so that the first and second clamp members 28 and 30 engage the rims of the door frames.

Once the clamp members 28 and 30 engage the rims 22 of the door frames 24, the clamp may be positioned relative to the front and rear of the vehicle to adjust to the length of the reach of the law enforcement officer. When the clamp 12 is suitably positioned, the user threads the nuts 144 and 146 on the tightening posts 132 and 134 to pull the second clamp member 30 toward the first clamp member 28 so that the clamp 12 tightly clamps the rims 22 of the vehicle 20 to mount the vehicle gun rack 10 to the vehicle 20. Finally, the nut 87 is tightened on threaded post 85.

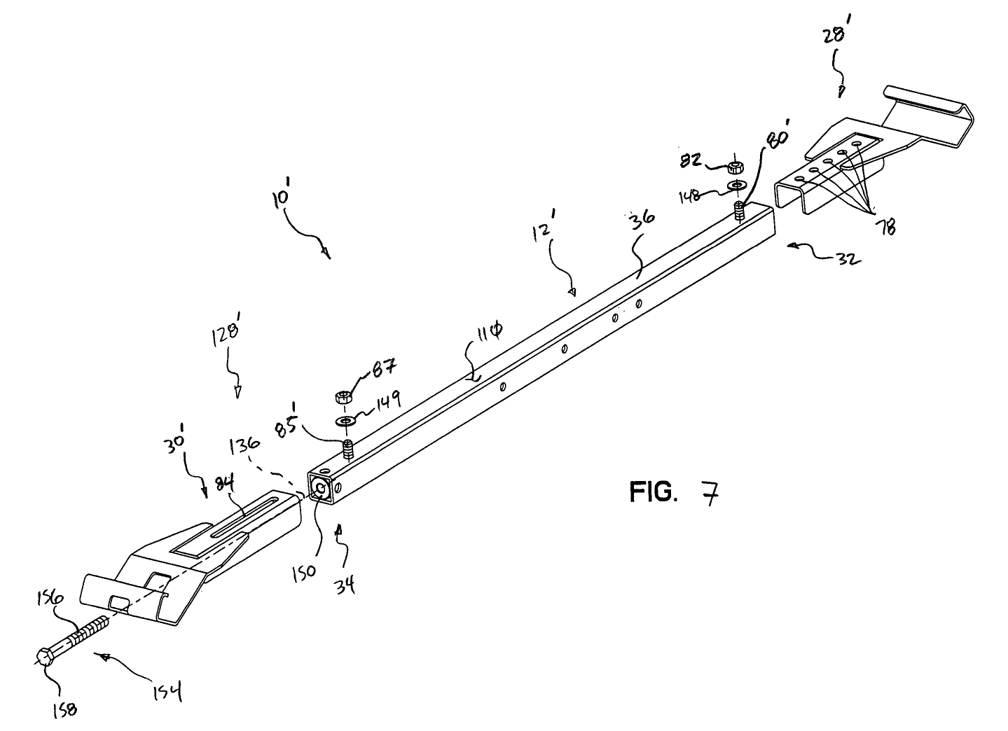

A further illustrative embodiment gun rack 10′ includes a clamp 12′ as illustrated in FIGS. 6-8. Except for alternative embodiment tightener 128′, clamp 12′ is substantially identical to clamp 12. As such, in the following description like reference components are identified by like reference numerals.

The first clamp member 28′ of gun rack 10′ is substantially the same as first clamp member 28 of clamp 12 as described above. It should be noted that first clamp member 28′ includes five spaced-apart openings 78 configured to facilitate longitudinal adjustment of the first clamp member 28′.

The second clamp member 30′ of gun rack 10′ is substantially similar to second clamp member 30 of clamp 12 as described above. Both the first and second clamp members 28′ and 30′ receive threaded posts 80′ and 85′ which are secured, illustratively, through welding, to the top 110 of frame member 36. Washers 148 and 149 may be positioned intermediate respective nuts 82 and 87 and clamp members 28′ and 30′.

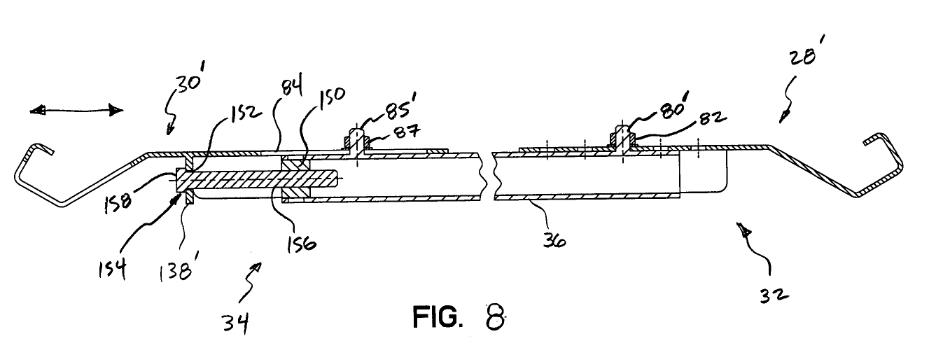

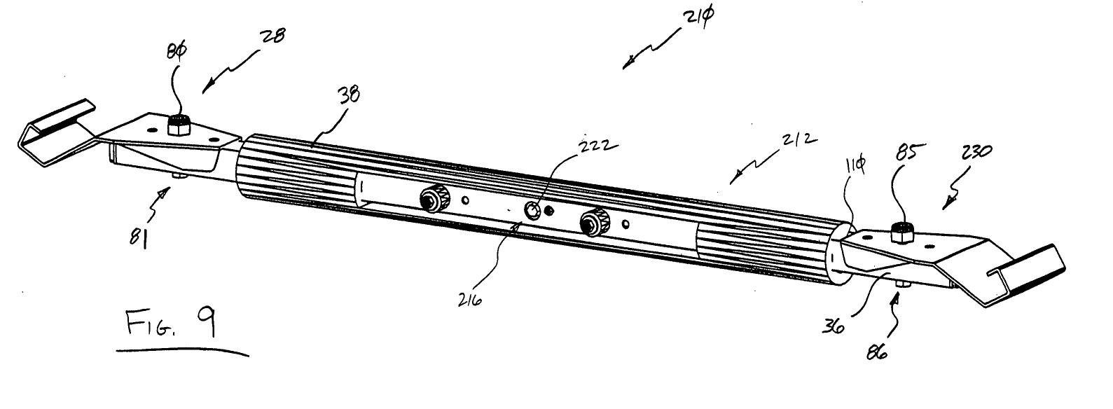

The tightener 128′ of gun rack 10′, like tightener 128 of gun rack 10 described above, couples the second end 34 of the frame member 36 to the second clamp member 30′. The tightener 128′ includes a threaded insert 150 coupled to the second end 34 of the frame member 36 and coaxially disposed with the longitudinal axis 136 of frame member 36. A tightening tab 138′ (FIG. 8) extends downwardly from the second clamp member 30′ and includes an aperture 152 configured to be coaxially aligned with the insert 150. A user input, illustratively, a tightening bolt 154 including a threaded shaft 156 is configured to pass through aperture 152 of tab 138′ and to be threadably received within the insert 150. A head 158 of bolt 154 is configured to engage the tab 138′. As detailed above, the second clamp member 30′ includes an elongated slot 84 which receives the threaded post 85′. As the shaft 156 of bolt 154 is rotated into the threaded inset 150, the head 158 causes the tightening tab 138′ and the second clamp to move relative to the frame member 36, and hence the first clamp member 28′ which is fixed to the frame member 36.

Installation of the vehicle gun rack 10′ is similar to that of gun rack 10 as detailed above. However, the tightener 128′ is operated by rotating the tightening bolt 154 into the threaded insert 150 so that the clamp 12′ tightly clamps the rims 22 of the vehicle 20 thereby mounting the gun rack 10′ to the vehicle 20.

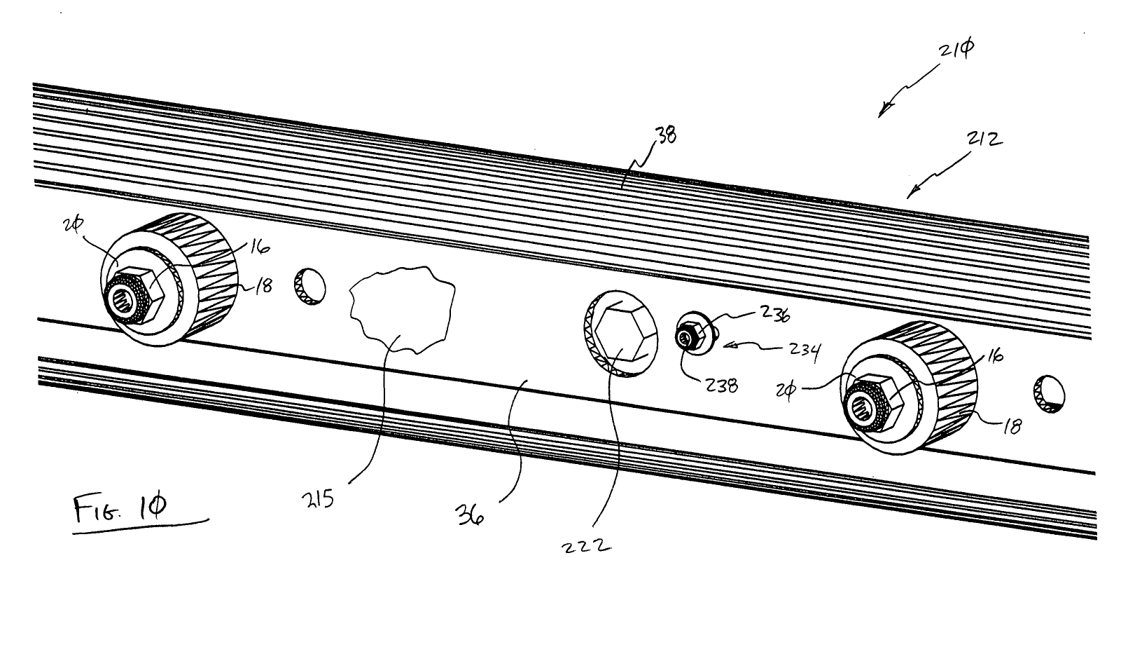

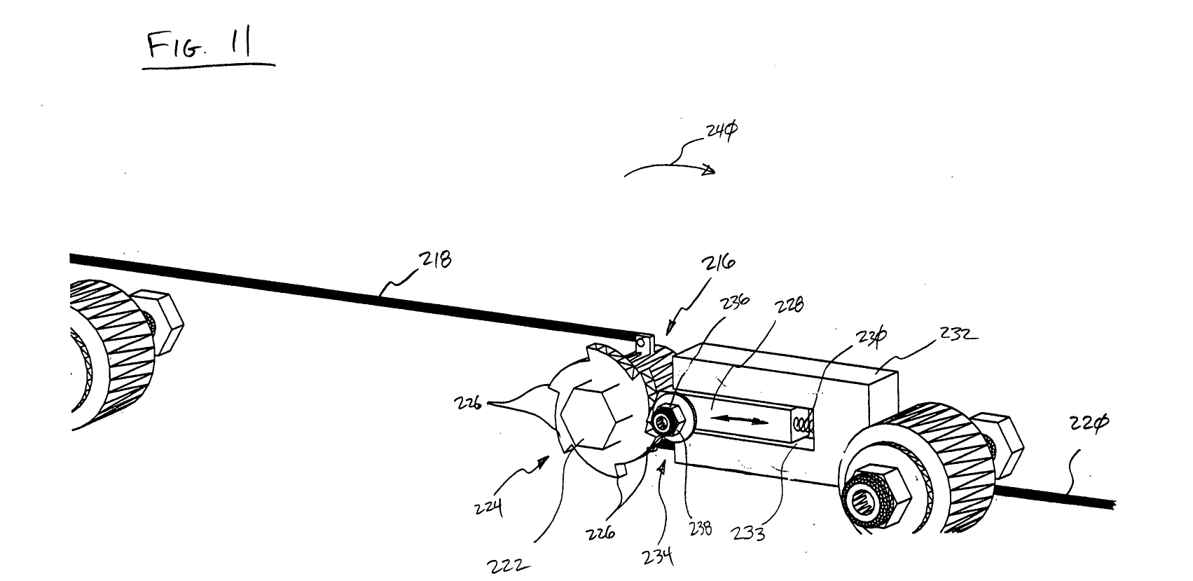

Turning now to FIGS. 9-11, a further illustrative embodiment gun rack 210 of the present invention is illustrated as including a clamp 212. In the following description, it should be appreciated that like components are identified by like reference numerals.

The first clamp member 28 of the gun rack 210 is substantially the same as that identified above with respect to the clamp 12. The second clamp member 230 is likewise substantially identical to the first clamp member 28 identified above. The first and second clamp members 28 and 230 are secured to the frame member 36 through fasteners 81 and 86 in a manner similar to that identified above with respect to the clamp 12.

The gun rack 210 includes a tensioning or tightening device 214 disposed within an interior chamber 215 defined by the frame 36. The tensioning device 214 includes a rotatably supported tensioning wheel 216 coupled to first and second connecting members 218 and 220 which, in turn, are coupled to the first and second clamp members 28 and 230, respectively. More particularly, the first and second connecting members 218 and 220 operably connect the wheel 216 to the threaded posts 80 and 85 of the fasteners 81 and 86, which couple the first and second clamp members 28 and 230 to the frame member 36. The posts 80 and 85 are slidably movable within slots (not shown) formed within the top 110 of the frame member 36.

The wheel 216 includes a gripping portion 222 which may be accessed through a conventional tool, such as a wrench. The wheel 216 further includes a ratcheting mechanism 224 configured to permit rotation of the wheel 216 in a first direction while preventing rotation of the wheel 216 in a second direction opposite the first direction. The ratcheting mechanism 224 including teeth 226 and a pawl 228 is configured to engage the teeth 226. The pawl 228 is biased toward the teeth 226 through the use of a spring 230, wherein the pawl 228 and the spring 230 are received within a retaining block 232. More particularly, the pawl 228 is supported for sliding movement within a slot 233 formed within the retaining block 232. A lock 234, in the form of a nut 236 threadably received on a shaft 238 may be utilized to secure the locking pawl 228 in position once the clamp members 28 and 230 have been set in position. The lock 234 secures the pawl 228 in locking engagement with the teeth 226.

The tensioning device of the vehicle gun rack 210 operates through rotation of the tensioning wheel 216. For example, rotation of the tensioning wheel 216 in a clockwise direction as indicated by arrow 240, results in inward longitudinal movement of both the first and second clamp members 28 and 230 relative to the frame member 36. Once the position is set, then the lock 234 is secured to prevent the locking pawl 228 from biasing inwardly and releasing the wheel 216 for rotation.

Although the invention has been described in detail with reference to certain illustrative embodiments, variations and modifications exist within the scope and spirit of the invention as described and as defined in the following claims.

1. A clamp for securing a gun rack to a vehicle, the clamp comprising:
an elongated frame member including opposing first and second ends;
a first clamp member coupled to the frame member at the first end and configured to grip a door frame;
a second clamp member coupled to the frame member at the second end in spaced relation to the first clamp member and configured to grip a door frame; and
a tightener including a user input supported by to the frame member at the second end and configured to drive the second clamp member in movement toward the first clamp member.

2. The clamp of claim 1, wherein:
the tightener includes a threaded post coupled to the second end of the frame member, and a tightening tab coupled to the second clamp member and slidably receiving the post; and
the user input includes a nut threadably received on the post, the nut being configured to drive the tab in movement relative to the threaded post as the nut is rotated on the post in a direction causing movement toward the first clamp member.

3. The clamp of claim 2, wherein the tightener includes a parallel pair of threaded posts and a pair of nuts threadably received on the pair of posts.

4. The clamp of claim 1, wherein:
the tightener includes a threaded insert coupled to the second end of the frame member, and a tightening tab coupled to the second clamp member and coaxially aligned with the threaded insert; and
the user input includes a bolt threadably received within the insert, the bolt being configured to drive the tab in movement relative to the insert as the bolt is rotated within the insert in a direction causing movement toward the first clamp member.

5. The clamp of claim 1, further comprising a threaded post extending upwardly from the frame proximate the second end, the second clamp member including a longitudinally extending slot receiving the threaded post wherein the second clamp member is configured to slidably move relative to the threaded post.

6. The claim of claim 5, further comprising a threaded post extending upwardly from the frame proximate the first end, the first clamp member including a plurality of openings configured to selectively receive the threaded post.

7. A weapon holder apparatus configured to be mounted between a first door frame and a second door frame of a vehicle, the weapon holder apparatus comprising:
a frame member having a first end and a second end;
a weapon holder coupled to the frame member;
a first clamp member coupled to the first end of the frame member, the first clamp member being configured to engage the first door frame;
a second clamp member coupled to the second end of the frame member, the second clamp member being configured to engage the second door frame; and
a tightener including a threaded insert coupled to the second end of the frame member, a tightening tab coupled to the second clamp member and coaxially aligned with the threaded insert, and a tightening bolt threadably received within the insert, the bolt being configured to drive the tab in movement relative to the insert as the bolt is rotated within the insert in a direction causing movement toward the first clamp member.

8. The apparatus of claim 7, wherein the first clamp is fixed to the first end of the frame member, and the second clamp is slidably coupled to the second end of the frame member to permit the distance between the first clamp and the second clamp to be adjusted.

9. The apparatus of claim 8, further comprising a threaded post extending upwardly from the frame member proximate the second end, the second clamp member including a longitudinally extending slot receiving the threaded post wherein the second clamp member is configured to slidably move relative to the threaded post.

10. The apparatus of claim 9, further comprising a threaded post extending upwardly from the frame member proximate the first end, the first clamp member including a plurality of openings configured to selectively receive the threaded post.

11. The apparatus of claim 7, wherein the tightening bolt includes a threaded shaft coupled to a head, the threaded shaft received within the threaded insert and the head being selectively engageable with the tightening tab for driving the tab in movement.

12. A clamp for fixing a gun rack to a vehicle, the clamp comprising:
an elongated frame member having a first end and a second end, the frame member defining an interior chamber;
a first clamp member supported by the frame member for longitudinal movement relative to the frame member;
a second clamp member supported by the frame member for longitudinal movement relative to the frame member; and
a tensioning device supported within the interior chamber of the frame member and operably coupled to the first and second clamp members, wherein movement of the tensioning device causes simultaneous movement of both the first and second clamp members relative to the elongated frame member.

13. The clamp of claim 12, wherein the tensioning device includes a rotatably supported tensioning wheel, a first connecting member coupled to the tensioning wheel and the first clamp member, and a second connecting member coupled to the tensioning wheel and the second clamp member.

14. The clamp of claim 13, further comprising: a first threaded post extending upwardly from the frame member proximate the first end, the first clamp member including an opening configured to receive the first threaded post; and a second threaded post extending upwardly from the frame member proximate the second end, the second clamp member including an opening configured to receive the second threaded post.

15. The clamp of claim 14, wherein the first and second connecting members couple the tensioning wheel to the first and second threaded posts such that rotation of the wheel causes simultaneous sliding movement of the first and second clamp members relative to the frame.

16. The clamp of claim 12, further comprising a ratcheting mechanism operably coupled to the tensioning wheel and configured to permit rotation of the tensioning wheel in a first direction while preventing rotation of the tensioning wheel in a second direction opposite the first direction.
